(19) United States
(12) Patent Application Publication
(10) Pub. No.: US 2015/0061623 A1
(43) Pub. Date: Mar. 5, 2015

(54) VOLTAGE REGULATOR OF LOW-DROP-OUTPUT TYPE AND OPERATION METHOD OF THE SAME

(71) Applicant: Samsung Electro-Mechanics Co., Ltd., Suwon (KR)

(72) Inventor: Soo Woong LEE, Suwon (KR)

(73) Assignee: SAMSUNG ELECTRO-MECHANICS CO., LTD., Suwon (KR)

(21) Appl. No.: 14/087,652

(22) Filed: Nov. 22, 2013

(30) Foreign Application Priority Data
Sep. 4, 2013 (KR) 10-2013-0106268

(51) Int. Cl. G05F 1/575

(52) U.S. Cl. CPC G05F 1/575
USPC 323/280

(57) ABSTRACT

There are provided a voltage regulator of a low-drop-output type, and an operation method of the same. The voltage regulator includes: an error amplifying unit providing a gate signal according to a voltage difference between a reference voltage and a feedback voltage; a semiconductor switch regulating a current between a supply voltage terminal and a ground according to the gate signal; a voltage detecting unit detecting the supply voltage to provide a detected voltage; a feedback control unit providing a feedback control signal according to the detected voltage; and a feedback voltage regulating unit connected between the semiconductor switch and the ground to regulate the feedback voltage according to the feedback control signal.

### CROSS-REFERENCE TO RELATED APPLICATIONS

This application claims the priority of Korean Patent Application No. 10-2013-0106268 filed on Sep. 4, 2013, in the Korean Intellectual Property Office, the disclosure of which is incorporated herein by reference.

### BACKGROUND OF THE INVENTION

1. Field of the Invention

The present invention relates to voltage regulator of a low-drop-output type and to an operation method of the same.

2. Description of the Related Art

In general, with continually evolving mobile communications technologies, a power amplifier is used for amplifying an output of a RF signal in a RF stage of a mobile communication terminal. In particular, a power amplifier using CMOS technologies suitable for light, thin, simple and integrated devices are being actively developed.

In order to stably operate such a power amplifier, a voltage regulator may be used in the power amplifier. A voltage regulator of a low-drop-output (LDO) type, inter alia, may be used, which may down-convert a supply voltage, may be simply designed, and may reduce current consumption.

Typical voltage regulators of the LDO type may include an operational amplifier, a PMOS transistor and a resistor circuit unit.

The operational amplifier, upon receiving a reference voltage in an inverting input terminal thereof, provides a first voltage, equal to the reference voltage, to a non-inverting input terminal thereof.

The PMOS transistor includes its source connected to the supply voltage terminal, and its gate and drain connected to the output terminal of the operation amplifier, and may be operated according to an output voltage from the operation amplifier to provide a current corresponding to the amplitude of the output voltage from the operational amplifier.

The resistor circuit unit includes a plurality of resistors connected to one another in series between the drain of the PMOS transistor and a ground, and may provide an output voltage obtained by multiplying the first voltage provided at the non-inverting input terminal of the operational amplifier by a fixed resistance ratio.

In the existing voltage regulator of the LDO type, an output voltage may vary as the supply voltage varies, and thus the voltage may vary in the non-inverting input terminal of the operation amplifier. In this case, an input offset may occur when the voltages between the inverting terminal and the non-inverting terminal of the operational amplifier do not match.

Therefore, in the existing voltage regulator of the LDO type, if an offset occurs in the operational amplifier, the voltage regulator operates unstably, fails to provide a desired gain or phase margin, and so on.

Patent Document 1 referenced below relates to a semiconductor device having an embedded regulator. However, the document does not teach removing an offset occurring when the supply voltage is varied.

### RELATED ART DOCUMENT

(Patent Document 1) Japanese Patent Laid-Open Publication No. 2000-0066744

### SUMMARY OF THE INVENTION

An aspect of the present invention provides a voltage regulator of a low-drop-output type capable of operating stable by way of removing an offset occurring when a supply voltage varies, and an operation method of the same.

According to an aspect of the present invention, there is provided a voltage regulator of a low-drop-output type, including: an error amplifying unit providing a gate signal according to a voltage difference between a reference voltage and a feedback voltage; a semiconductor switch regulating a current between a supply voltage terminal and a ground according to the gate signal; a voltage detecting unit detecting the supply voltage to provide a detected voltage; a feedback control unit providing a feedback control signal according to the detected voltage; and a feedback voltage regulating unit connected between the semiconductor switch and the ground to regulate the feedback voltage according to the feedback control signal.

The feedback voltage regulating unit may include first and second resistor circuit parts connected between the semiconductor switch and the ground, wherein the feedback voltage is provided at a connection node between the first and second resistor circuit parts, and wherein at least one of the first and second resistor circuit parts has a resistance value varying according to the feedback control signal.

According to another aspect of the present invention, there is provided a voltage regulator of a low-drop-output type, comprising: an error amplifying unit providing a gate signal according to a voltage difference between a reference voltage and a feedback voltage; a semiconductor switch regulating a current between a supply voltage terminal and a ground according to the gate signal; a voltage detecting unit detecting the supply voltage to provide a detected voltage; a feedback control unit providing a feedback control signal according to the detected voltage; and a feedback voltage regulating unit connected between the semiconductor switch and the ground to regulate the feedback voltage according to the feedback control signal, wherein the feedback voltage regulating unit includes first and second resistor circuit parts connected between the semiconductor switch and the ground, wherein the feedback voltage is provided at a connection node between the first and second resistor circuit parts, and wherein the first resistor circuit part has a resistance value varying according to the feedback control signal.

According to another aspect of the present invention, there is provided a voltage regulator of a low-drop-output type, comprising: an error amplifying unit providing a gate signal according to a voltage difference between a reference voltage and a feedback voltage; a semiconductor switch regulating a current between a supply voltage terminal and a ground according to the gate signal; a voltage detecting unit detecting the supply voltage to provide a detected voltage; a feedback control unit providing a feedback control signal according to the detected voltage; and a feedback voltage regulating unit connected between the semiconductor switch and the ground to regulate the feedback voltage according to the feedback control signal, wherein the feedback voltage regulating unit includes first and second resistor circuit parts connected between the semiconductor switch and the ground, wherein the feedback voltage is provided at a connection node between the first and second resistor circuit parts, and wherein the second resistor circuit part has a resistance value varying according to the feedback control signal.

The error amplifying unit may include an operational amplifier having an inverting input terminal to receive the reference voltage, an non-inverting input terminal to receive the feedback voltage, and an output terminal connected to the semiconductor switch to provide the gate signal, and wherein the gate signal has a level corresponding to the voltage difference between the reference voltage and the feedback voltage.

The semiconductor switch may include a PMOS transistor having its source connected to the supply voltage terminal, its gate connected to an output terminal of the error amplifying unit, and a drain connected to the feedback voltage regulating unit, wherein the PMOS transistor regulates a source-drain current according to the gate signal.

The voltage detecting unit may include at least two detection resistors, first and second detection resistors connected between the supply voltage terminal and the ground, wherein the detected voltage is provided at a connection node between the first and second detection resistors.

The feedback control unit may provide a feedback control signal including first to nth control signals, states of the first to nth control signals being determined according to an amplitude of the detected voltage.

The feedback control unit may include: a comparator comparing the detected voltage with first to nth reference voltages to provide first to Nth comparison signals, respectively, wherein the first to Nth comparison signals have a high level if the detected voltage is higher than corresponding reference voltages and have a low level otherwise, and a decoder decoding the first to Nth comparison signals into first to nth control signals of the feedback control signals to provide the feedback voltage regulating unit with the decoded signals.

The first resistor circuit part may include first to Nth switched resistors connected to one another in parallel to be switched on or off according to the feedback control signal, wherein each of the first to Nth switched resistors includes a switch and a resistor connected to each other in series.

According to another aspect of the present invention, there is provided an operation method of a voltage regulator of a low-drop-output type having an error amplifying unit providing a gate signal according to a voltage difference between a reference voltage and a feedback voltage and a semiconductor switch regulating a current between a supply voltage terminal and a ground according to the gate signal, the method including: detecting, by a voltage detecting unit, the supply voltage to provide a detected voltage; providing, by a feedback control unit, a feedback control signal according to the detected voltage; and regulating, by a feedback voltage regulating unit connected between the semiconductor switch and the ground, the feedback voltage according to the feedback control signal.

The error amplifying unit may include an operational amplifier having an inverting input terminal to receive the reference voltage, an non-inverting input terminal to receive the feedback voltage, and an output terminal connected to the semiconductor switch to provide the gate signal, and wherein the gate signal has a level corresponding to the voltage difference between the reference voltage and the feedback voltage.

The semiconductor switch may include a PMOS transistor having its source connected to the supply voltage terminal, its gate connected to an output terminal of the error amplifying unit, and a drain connected to the feedback voltage regulating unit, wherein the PMOS transistor regulates a source-drain current according to the gate signal.

The providing of the feedback control signal may include: comparing, by the feedback control unit, the detected voltage with first to nth reference voltages to provide first to Nth comparison signals, respectively; and decoding the first to Nth comparison signals into first to nth control signals of the feedback control signals to provide the feedback voltage regulating unit with the decoded signals, wherein the first to Nth comparison signals have a high level if the detected voltage is higher than corresponding reference voltages and have a low level otherwise.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a voltage regulator according to an embodiment of the present invention;

FIG. 2 is a circuit diagram illustrating an example of the feedback voltage regulating unit according to the embodiment of the present invention;

FIG. 3 is a circuit diagram illustrating another example of the feedback voltage regulating unit according to the embodiment of the present invention;

FIG. 4 is a diagram illustrating feedback control signals from the feedback control unit according to the embodiment of the present invention;

FIG. 5 is a diagram illustrating an implementation example of the feedback control unit according to the embodiment of the present invention;

FIG. 6 is a circuit diagram illustrating an implementation example of the feedback voltage regulating unit according to the embodiment of the present invention;

FIG. 7 is a circuit diagram illustrating another implementation example of the feedback voltage regulating unit according to the embodiment of the present invention;

FIG. 8 is a diagram illustrating an example of the feedback control unit according to the embodiment of the present invention;

FIG. 9 is a circuit diagram illustrating an example of the feedback voltage regulating unit according to the embodiment of the present invention;

FIG. 10 is a flowchart illustrating an operation method of the voltage regulator according to an embodiment of the present invention; and

FIG. 11 is a flowchart illustrating a process of providing a feedback control signal according to the embodiment of the present invention.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

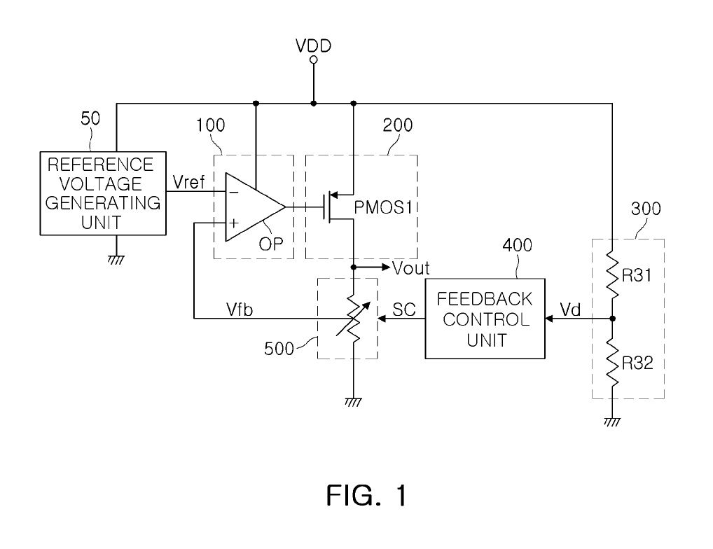

FIG. 1 is a block diagram of a voltage regulator according to an embodiment of the present invention.

Referring to FIG. 1, the voltage regulator according to the embodiment of the present invention may include an error amplifying unit 100, a semiconductor switch 200, a voltage detecting unit 300, a feedback control unit 400, and a feedback voltage regulating unit 500.

The voltage regulator may further include a reference voltage generating unit 50 to generate a reference voltage V_{ref}.

The error amplifying unit 100 may generate a gate signal SG according to a voltage difference between a predetermined reference voltage Vref and a feedback voltage Vfb to provide the semiconductor switch 200 with a gate signal SG.

As an exemplary implementation, the error amplifying unit 100 may include an operational amplifier OP1 having an inverting input terminal to receive the reference voltage Vref, a non-inverting input terminal to receive the feedback voltage Vfb, and an output terminal connected to the semiconductor switch 200 to provide the gate signal SG.

The operation amplifier OP1 may provide the semiconductor switch 200 with a gate signal SG having a level corresponding to a voltage difference between a reference voltage Vref received at the inverting input terminal and a feedback voltage Vfb received at the non-inverting input terminal.

For example, if the reference voltage Vref is greater than the feedback voltage Vfb, the operational amplifier OP1 may provide the semiconductor switch 200 with a gate signal SG having a level sufficient to switch on the semiconductor switch 200. If the reference voltage V_{ref} is not greater than the feedback voltage Vfb, the operational amplifier OP1 may provide the semiconductor switch 200 with a gate signal SG having a level sufficient to switch off the semiconductor switch 200.

The semiconductor switch 200 may regulate a current between a supply voltage VDD terminal and a ground according to the gate signal SG. Here, the semiconductor switch 200 may be a switching element such as a transistor. For example, when the semiconductor switch 200 is switched on, a current flow is determined by a total resistance from the supply voltage VDD terminal to the ground and the supply voltage VDD.

The semiconductor switch 200 may include a PMOS transistor PMOS1 having its source connected to the supply voltage VDD terminal, its gate connected to the output terminal of the error amplifying unit 100, and its drain connected to the feedback voltage regulating unit 500.

Here, the PMOS transistor PMOS1 may regulate a source-drain current according to the gate signal SG. For example, the PMOS transistor PMOS1 is turned on when the gate signal SG is in a low level and is turned off when the gate signal SG is at a high level.

The voltage detecting unit 300 may detect the supply voltage VDD to provide a detected voltage Vd.

As an exemplary implementation, the voltage detecting unit 300 may include at least two resistors, i.e., a first detection resistor R31 and a second detection resistor R32 connected between the supply voltage VDD terminal and the ground.

The detected voltage Vd may be provided at a connection node between the first detection resistor R31 and the second detection resistor R32. For example, in the case that the ratio of the resistance between the first detection resistor R31 and the second detection resistor R32 was 5:1, that the supply voltage VDD was 6V, and that the reference voltage V_{ref} was 2.5V, the detected voltage Vd would be 1V.

The feedback control unit 400 may provide a feedback control signal SC according to the detected voltage Vd. The feedback control signal SC may have different signals to regulate the feedback voltage Vfb from the feedback voltage regulating unit 500 depending on the amplitude of the detected voltage Vd.

The feedback voltage regulating unit 500 may be connected between the semiconductor switch 200 and the ground to regulate the feedback voltage Vfb according to the feedback control signal SC. For example, the feedback voltage regulating unit 500 may include a resistor circuit in which a resistor that determines the feedback voltage Vfb is varied according to the feedback control signal SC. The resistor circuit may regulate the feedback voltage Vfb.

In addition, the feedback voltage regulating unit 500 includes a resistor circuit connected between the semiconductor switch 200 and the ground, by which an output voltage Vout amplified from the feedback voltage is provided at the non-inverting input terminal of the operational amplifier OP1

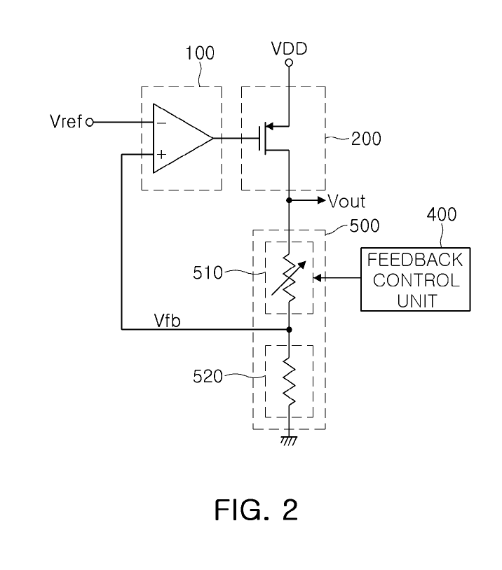

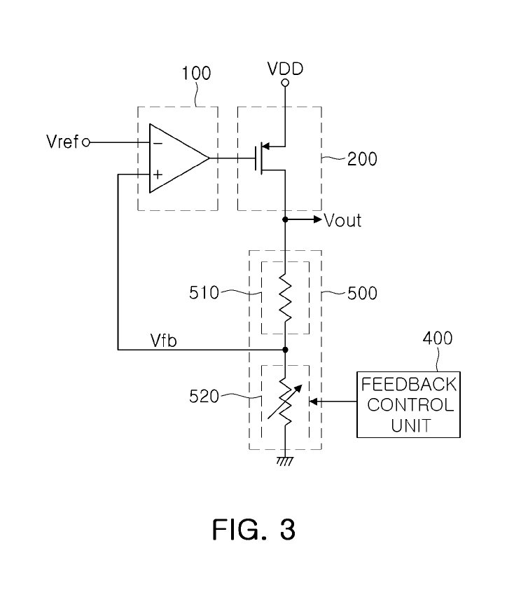

FIG. 2 is a circuit diagram of an example of the feedback voltage regulating unit according to the embodiment of the present invention, and FIG. 3 is a circuit diagram of another example of the feedback voltage regulating unit according to the embodiment of the present invention.

Referring to FIGS. 2 and 3, the feedback voltage regulating unit 500 may include a first resistor circuit part 510 and a second resistor circuit part 520 connected between the semiconductor switch 200 and the ground. The feedback voltage Vfb may be provided at a connection node between the first resistor circuit part 510 and the second resistor circuit part 520.

The resistance value of at least one of the first resistor circuit part 510 and the second resistor circuit part 520 may vary according to the feedback control signal SC.

As shown in FIG. 2, the first resistor circuit part 510 may be a variable resistance circuit the resistance value of which varies according to the feedback control signal SC.

Alternatively, as shown in FIG. 3, the second resistor circuit part 520 may be a variable resistance circuit the resistance value of which varies according to the feedback control signal SC.

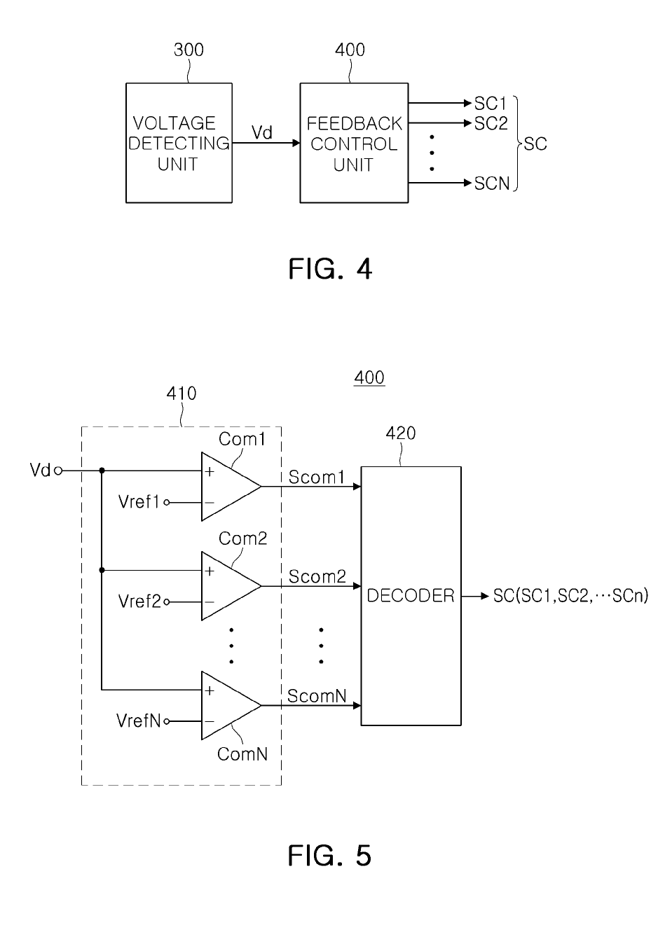

FIG. 4 is a diagram illustrating feedback control signals from the feedback control unit according to the embodiment of the present invention. Referring to FIG. 4, the feedback control unit 400 may provide feedback control signals SC including first to nth control signals SC1 to SCN, the state of which is determined according to the amplitude of the detected voltage Vd.

FIG. 5 is a diagram illustrating an implementation example of the feedback control unit according to the embodiment of the present invention.

Referring to FIG. 5, the feedback control unit 400 may include a comparator unit 410 and a decoder 420.

The comparator unit 410 may include first to nth comparators com1 to comN that compare the detected voltage Vd with first to nth reference voltages V_{ref}1 to V_{refN} to provide first to Nth comparison signals S_{com1} to S_{comN}, respectively.

The first to nth comparators com1 to comN may provide first to Nth comparison signals Scom1 to ScomN, respectively, each of which has a high level if the detected voltage Vd is higher than its reference voltage and otherwise has a low level.

The decoder 420 may decode the first to Nth comparison signals Scom1 to ScomN into first to nth control signals SC1 to SCN of the feedback control signal SC, respectively, and provide the decoded signals to the feedback voltage regulating unit 500.

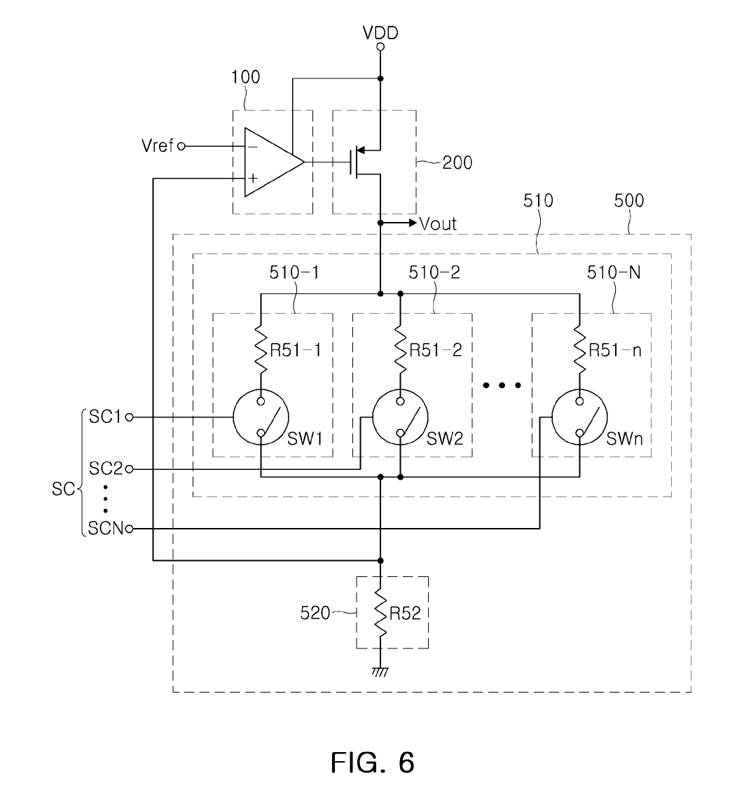

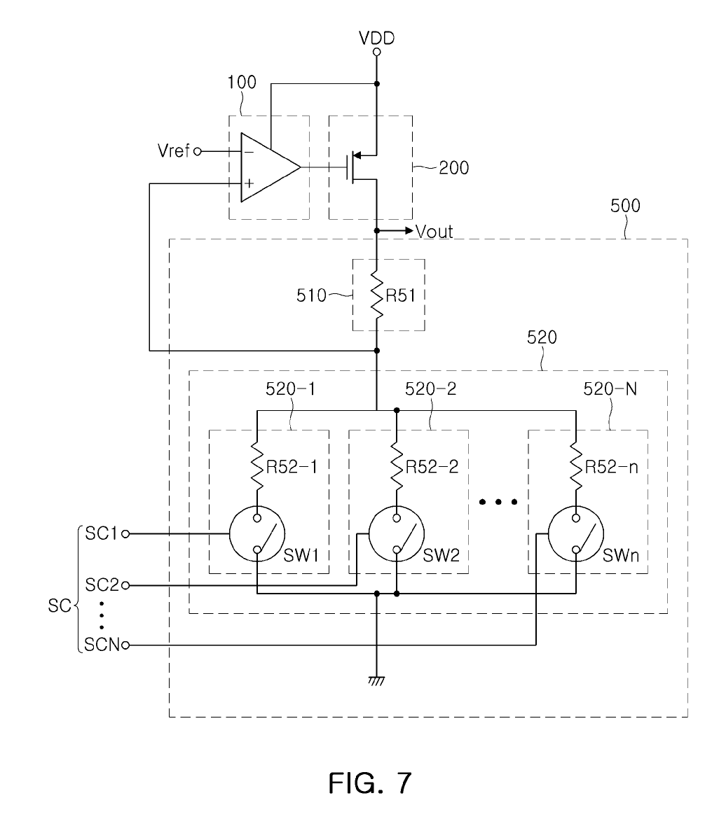

Now, exemplary implementations of the first resistor circuit part 510 and the second resistor circuit part 520 will be described with reference to FIGS. 6 and 7. As described above, at least one of the first resistor circuit part 510 and the second resistor circuit part 520 may be a variable resistance circuit with resistance values varying according to the feedback control signal SC. Exemplary implementations thereof will be described with reference to FIGS. 6 and 7.

FIG. 6 is a circuit diagram illustrating an implementation example of the feedback voltage regulating unit according to the embodiment of the present invention.

Referring to FIG. 6, the first resistor circuit part 510 may include first to Nth switched resistors 510-1 to 510-N that are connected to each other in parallel and are switched on or off according to the feedback control signal SC.

Each of the first to Nth switched resistors 510-1 to 510-N may include a switch and a resistor connected to each other in series.

For example, the first switched resistor 510-1 may include a switch SW1 and a resistor R51-1 connected to each other in series. The second switched resistor 510-2 may include a switch SW2 and a resistor R51-2 connected to each other in series. Further, the Nth switched resistor 510-N may include a switch SWN and a resistor R51-N connected to each other in series. Here, the first to Nth switched resistors 510-1 to 510-N may be switched on or off according to the first to nth control signals SC1 to SCN, respectively.

FIG. 7 is a circuit diagram illustrating another implementation example of the feedback voltage regulating unit according to the embodiment of the present invention.

Referring to FIG. 7, the second resistor circuit part 520 may include first to Nth switched resistors 520-1 to 520-N that are connected to each other in parallel and are switched on or off according to the feedback control signal SC.

Each of the first to Nth switched resistors 520-1 to 520-N may include a switch and a resistor connected to each other in series.

For example, the first switched resistor 520-1 may include a switch SW1 and a resistor R52-1 connected to each other in series. The second switched resistor 520-2 may include a switch SW2 and a resistor R52-2 connected to each other in series. Further, the Nth switched resistor 520-N may include a switch SWN and a resistor R52-N connected to each other in series. Here, the first to Nth switched resistors 520-1 to 520-N may be switched on or off according to the first to nth control signals SC1 to SCN, respectively.

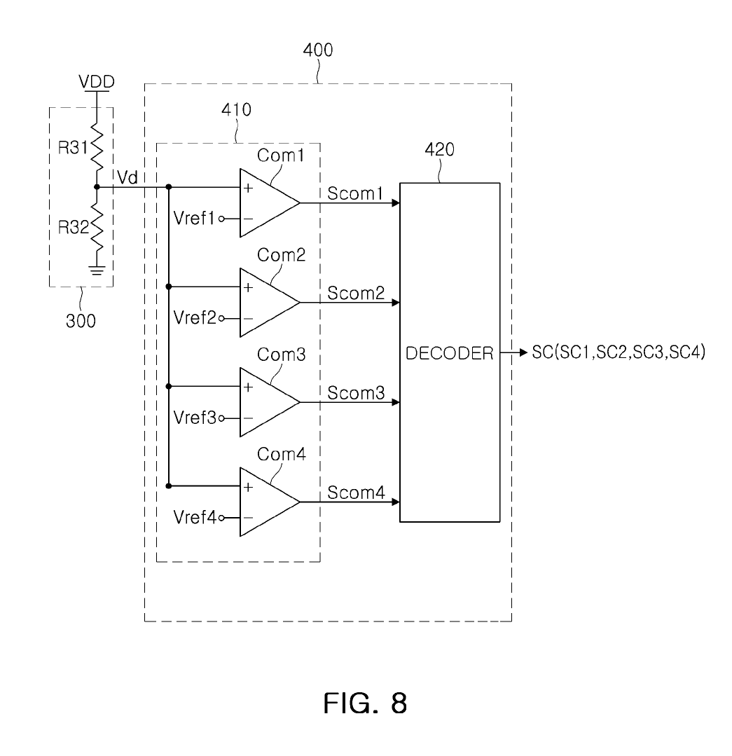

Now, the operations of the feedback control unit 400 and the feedback voltage regulating unit 500 will be described with reference to FIGS. 8 to 10.

FIG. 8 is a diagram illustrating an example of the feedback control unit according to the embodiment of the present invention.

Referring to FIG. 8, the comparator unit 410 of the feedback control unit 400 may include first to nth comparators com1 to comN that compare the detected voltage Vd with first to 4th reference voltages V_{ref1} to V_{ref4} to provide first to Nth comparison signals S_{com1} to S_{com4}, respectively.

First, the operation of the comparator unit 410 will be described. The first to fourth comparators com1 to com4 may provide first to 4th comparison signals S_{com1} to S_{com4}, respectively, each of which has a high level if the detected voltage Vd is higher than its reference voltage and otherwise has a low level.

For example, if the detected voltage Vd is higher than the first reference voltage V_{ref1} (e.g., 1V), the first to fourth comparators com1 to com4 may output first to fourth comparison signals S_{com1} to S_{com4} of a high level, respectively.

For another example, if the detected voltage Vd is lower than the first reference voltage V_{ref1} (e.g., 1V) and higher than the second reference voltage V_{ref2} (e.g., 0.9V), the second to fourth comparators com2 to com4 may output the second to fourth comparison signals S_{com2} to S_{com4} of a high level, respectively, while the first comparison signal S_{com1} becomes a lower level.

For another example, if the detected voltage Vd is lower than the second reference voltage V_{ref2} (e.g., 0.9V) and higher than the third reference voltage V_{ref3} (e.g., 0.8V), the third and fourth comparators com3 and com4 may output the third and fourth comparison signals S_{com3} and S_{com4} having high levels, respectively, while the first and second comparison signals S_{com1} and S_{com2} are reduced to a lower level.

Further, if the detected voltage Vd is lower than the third reference voltage V_{ref3} (e.g., 0.8V) and higher than the fourth reference voltage V_{ref4} (e.g., 0.72V), the fourth comparator com4 may output the fourth comparison signal S_{com4} of a high level, while the first to third comparison signals S_{com1} to S_{com3} become a lower level.

Second, the operation of the decoder 420 will be described. The decoder 420 may decode the first to fourth comparison signals S_{com1} to S_{com4} into first to fourth control signals SC1 to SC4, respectively, and provide the decoded signals to the feedback voltage regulating unit 500.

For example, if all of the first to fourth comparison signals S_{com1} to S_{com4} are a high level, only the first control signal SC1 of the first to fourth control signals S_{com1} to S_{com4} is output at switching-on level.

For example, if the first to fourth comparison signals S_{com1} to S_{com4} are a L (low level), H, H and H, respectively, only the second control signal SC2 of the first to fourth control signals S_{com1} to S_{com4} is output at switching-on level.

For another example, if the first to fourth comparison signals S_{com1} to S_{com4} are a L, L, H and H, respectively, only the third control signal SC3 of the first to fourth control signals S_{com1} to S_{com4} is output at switching-on level.

If the first to fourth comparison signals S_{com1} to S_{com4} are a L, L, L and H, respectively, only the fourth control signal SC4 of the first to fourth control signals S_{com1} to S_{com4} is output at switching-on level.

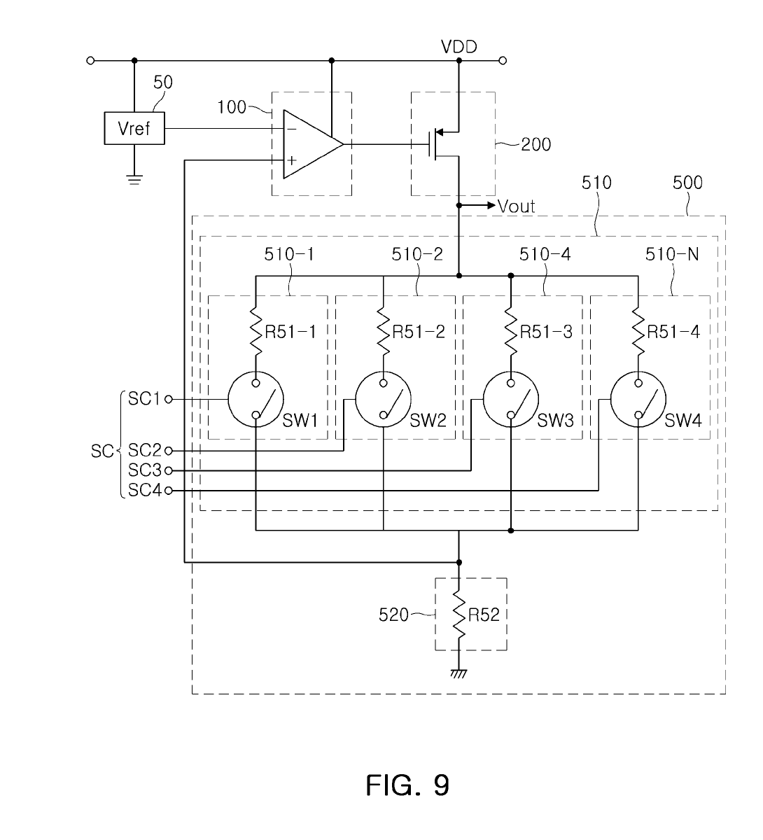

FIG. 9 is a circuit diagram illustrating an example of the feedback voltage regulating unit according to the embodiment of the present invention.

Referring to FIG. 9, the first resistor circuit part 510 may include first to fourth switched resistors 510-1 to 510-4 that are connected to each other in parallel and are switched on or off according to the feedback control signal SC.

Each of the first to fourth switched resistors 510-1 to 510-4 may include a switch and a resistor connected to each other in series.

For example, the first switched resistor 510-1 may include a switch SW1 and a resistor R51-1 connected to each other in series. The second switched resistor 510-2 may include a switch SW2 and a resistor R51-2 connected to each other in series. The third switched resistor 510-3 may include a switch SW3 and a resistor R51-3 connected to each other in series. The fourth switched resistor 510-4 may include a switch SW4 and a resistor R51-4 connected to each other in series.

Here, the first to fourth switched resistors 510-1 to 510-4 may be switched on or off according to the first to fourth control signals SC1 to SC4, respectively.

For example, if the supply voltage VDD is 6V, when only the first control signal SC1 of the first to fourth control signals SC1 to SC4 is at the switching-on level, only the first switched resistor 510-1 of the first to fourth switched resistor 510-1 to 510-4 is closed. At this time, if the ratio of the resistance values between the resistor R51-1 included in the first switched resistor 510-1 and the resistor R52 of the second resistor circuit part 520 is 1:1, the feedback voltage Vfb at the connection node between the first and second resistor circuit parts 510 and 520 is equal to the reference voltage V_{ref} (e.g., 2.5V), and the feedback voltage regulating unit 500 may provide the output voltage Vout of 5V, obtained by multiplying the feedback voltage Vfb by two times.

Or, if the supply voltage VDD is 5.4V, when only the second control signal SC2 of the first to fourth control signals SC1 to SC4 is the switching-on level, only the second switched resistor 510-2 of the first to fourth switched resistor 510-2 to 510-4 is closed.

At this time, if the ratio of the resistance values between the resistor R51-2 included in the second switched resistor 510-2 and the resistor R52 of the second resistor circuit part 520 is 1:0.9, the feedback voltage Vfb at the connection node between the first and second resistor circuit parts 510 and 520 is equal to the reference voltage V_{ref} (e.g., 2.5V), and the feedback voltage regulating unit 500 may provide the output voltage Vout of 4.75V, obtained by multiplying the feedback voltage Vfb by 1.9 times.

For another example, if the supply voltage VDD is 4.8V, when only the third control signal SC3 of the first to fourth control signals SC1 to SC4 is the switching-on level, only the third switched resistor 510-3 of the first to fourth switched resistor 510-1 to 510-4 is closed.

At this time, if the ratio of the resistance values between the resistor R51-3 included in the third switched resistor 510-3 and the resistor R52 of the second resistor circuit part 520 is 1:0.8, the feedback voltage Vfb at the connection node between the first and second resistor circuit parts 510 and 520 is equal to the reference voltage V_{ref} (e.g., 2.5V), and the feedback voltage regulating unit 500 may provide the output voltage Vout of 4.5V, obtained by multiplying the feedback voltage Vfb by 1.8 times.

For another example, if the supply voltage VDD is 4.32V, when only the fourth control signal SC4 of the first to fourth control signals SC1 to SC4 is the switching-on level, only the fourth switched resistor 510-4 of the first to fourth switched resistor 510-1 to 510-4 is closed.

At this time, if the ratio of the resistance values between the resistor R51-4 included in the fourth switched resistor 510-4 and the resistor R52 of the second resistor circuit part 520 is 1:0.7, the feedback voltage Vfb at the connection node between the first and second resistor circuit parts 510 and 520 is equal to the reference voltage V_{ref} (e.g., 2.5V), and the feedback voltage regulating unit 500 may provide the output voltage Vout of 4.25V, obtained by multiplying the feedback voltage Vfb by 1.7 times.

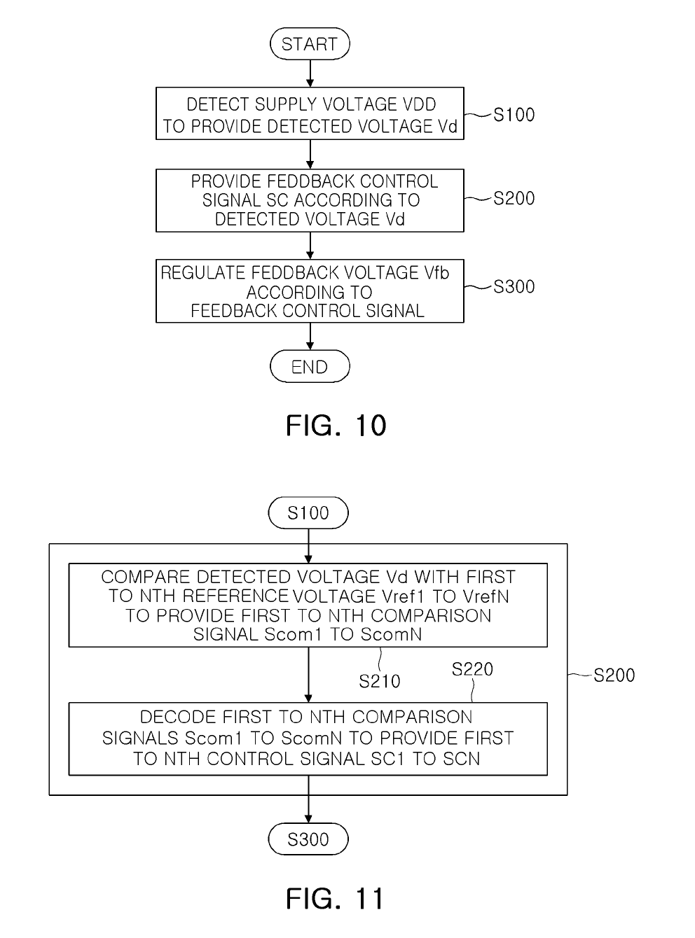

FIG. 10 is a flowchart illustrating the operation method of the voltage regulator according to the embodiment of the present invention, and FIG. 11 is a flowchart illustrating the process of providing the feedback control signal according to the embodiment of the present invention.

The operation method of the voltage regulator according to the embodiment of the present invention will be described with reference to FIGS. 1 to 11.

In describing the operation method of the voltage regulator according to the embodiment of the present invention, the above descriptions with reference to FIGS. 1 to 9 may be equally applied, and thus the same descriptions will not be repeated.

Referring to FIG. 10, in the operation method of the voltage regulator of a low-drop-output type mentioned earlier, the voltage detecting unit 300 may detect the supply voltage VDD to provide the detected voltage Vd (S100).

Then, the feedback control unit 400 may provide the feedback control signal SC according to the detected voltage Vd (S200).

The feedback voltage regulating unit 500 connected between the semiconductor switch 200 and the ground may regulate the feedback voltage Vfb according to the feedback control signal SC (S300).

The providing of the feedback control signal SC (S200) will be described with reference to FIG. 11.

First, the feedback control unit 400 may compare the detected voltage Vd with each of the first to nth reference voltages V_{ref1} to V_{refN} to provide first to Nth comparison signals S_{com1} to S_{comN} (S210).

Then, the first to Nth comparison signals S_{com1} to S_{comN} may be decoded into the first to nth control signals SC1 to SCN, respectively, and to be provided to the feedback voltage regulating unit 500 (S210).

At this time, the first to Nth comparison signals S_{com1} to S_{comN} may have a high level if the detected voltage Vd is higher than a corresponding reference voltage and has a low level otherwise.

As set forth above, according to the embodiments of the present invention, an offset occurring when a supply voltage varies is removed, so that stable operation is maintained even at a low supply voltage.

While the present invention has been shown and described in connection with the embodiments, it will be apparent to those skilled in the art that modifications and variations can be made without departing from the spirit and scope of the invention as defined by the appended claims.

What is claimed is:

1. A voltage regulator of a low-drop-output type, comprising:
an error amplifying unit providing a gate signal according to a voltage difference between a reference voltage and a feedback voltage;
a semiconductor switch regulating a current between a supply voltage terminal and a ground according to the gate signal;
a voltage detecting unit detecting the supply voltage to provide a detected voltage;
a feedback control unit providing a feedback control signal according to the detected voltage; and
a feedback voltage regulating unit connected between the semiconductor switch and the ground to regulate the feedback voltage according to the feedback control signal.

2. The voltage regulator of claim 1, wherein the error amplifying unit includes an operational amplifier having an inverting input terminal to receive the reference voltage, an non-inverting input terminal to receive the feedback voltage, and an output terminal connected to the semiconductor switch to provide the gate signal, and wherein the gate signal has a level corresponding to the voltage difference between the reference voltage and the feedback voltage.

3. The voltage regulator of claim 1, wherein the semiconductor switch includes a PMOS transistor having its source connected to the supply voltage terminal, its gate connected to an output terminal of the error amplifying unit, and a drain connected to the feedback voltage regulating unit, wherein the PMOS transistor regulates a source-drain current according to the gate signal.

4. The voltage regulator of claim 1, wherein the voltage detecting unit includes at least two detection resistors, first and second detection resistors connected between the supply voltage terminal and the ground, wherein the detected voltage is provided at a connection node between the first and second detection resistors.

5. The voltage regulator of claim 1, wherein the feedback control unit provides a feedback control signal including first to nth control signals, states of the first to nth control signals being determined according to an amplitude of the detected voltage.

6. The voltage regulator of claim 1, wherein the feedback voltage regulating unit includes first and second resistor circuit parts connected between the semiconductor switch and the ground, wherein the feedback voltage is provided at a connection node between the first and second resistor circuit parts, and wherein at least one of the first and second resistor circuit parts has a resistance value varying according to the feedback control signal.

7. A voltage regulator of a low-drop-output type, comprising:
an error amplifying unit providing a gate signal according to a voltage difference between a reference voltage and a feedback voltage;
a semiconductor switch regulating a current between a supply voltage terminal and a ground according to the gate signal;
a voltage detecting unit detecting the supply voltage to provide a detected voltage;
a feedback control unit providing a feedback control signal according to the detected voltage; and
a feedback voltage regulating unit connected between the semiconductor switch and the ground to regulate the feedback voltage according to the feedback control signal,
wherein the feedback voltage regulating unit includes first and second resistor circuit parts connected between the semiconductor switch and the ground,
wherein the feedback voltage is provided at a connection node between the first and second resistor circuit parts, and
wherein the first resistor circuit part has a resistance value varying according to the feedback control signal.

8. The voltage regulator of claim 7, wherein the error amplifying unit includes an operational amplifier having an inverting input terminal to receive the reference voltage, an non-inverting input terminal to receive the feedback voltage, and an output terminal connected to the semiconductor switch to provide the gate signal, and wherein the gate signal has a level corresponding to the voltage difference between the reference voltage and the feedback voltage.

9. The voltage regulator of claim 7, wherein the semiconductor switch includes a PMOS transistor having its source connected to the supply voltage terminal, its gate connected to an output terminal of the error amplifying unit, and a drain connected to the feedback voltage regulating unit, wherein the PMOS transistor regulates a source-drain current according to the gate signal.

10. The voltage regulator of claim 7, wherein the voltage detecting unit includes at least two detection resistors, first and second detection resistors connected between the supply voltage terminal and the ground, wherein the detected voltage is provided at a connection node between the first and second detection resistors.

11. The voltage regulator of claim 7, wherein the feedback control unit provides a feedback control signal including first to nth control signals, states of the first to nth control signals being determined according to an amplitude of the detected voltage.

12. The voltage regulator of claim 7, wherein the feedback control unit includes: a comparator comparing the detected voltage with first to nth reference voltages to provide first to Nth comparison signals, respectively, wherein the first to Nth comparison signals have a high level if the detected voltage is higher than corresponding reference voltages and have a low level otherwise, and a decoder decoding the first to Nth comparison signals into first to nth control signals of the feedback control signals to provide the feedback voltage regulating unit.

13. The voltage regulator of claim 7, wherein the first resistor circuit part includes first to Nth switched resistors connected to one another in parallel to be switched on or off according to the feedback control signal, wherein each of the first to Nth switched resistors includes a switch and a resistor connected to each other in series.

14. A voltage regulator of a low-drop-output type, comprising:
an error amplifying unit providing a gate signal according to a voltage difference between a reference voltage and a feedback voltage;
a semiconductor switch regulating a current between a supply voltage terminal and a ground according to the gate signal;
a voltage detecting unit detecting the supply voltage to provide a detected voltage;
a feedback control unit providing a feedback control signal according to the detected voltage; and
a feedback voltage regulating unit connected between the semiconductor switch and the ground to regulate the feedback voltage according to the feedback control signal,
wherein the feedback voltage regulating unit includes first and second resistor circuit parts connected between the semiconductor switch and the ground,
wherein the feedback voltage is provided at a connection node between the first and second resistor circuit parts, and
wherein the second resistor circuit part has a resistance value varying according to the feedback control signal.

15. The voltage regulator of claim 14, wherein the error amplifying unit includes an operational amplifier having an inverting input terminal to receive the reference voltage, an non-inverting input terminal to receive the feedback voltage, and an output terminal connected to the semiconductor switch to provide the gate signal, and wherein the gate signal has a level corresponding to the voltage difference between the reference voltage and the feedback voltage.

16. The voltage regulator of claim 14, wherein the semiconductor switch includes a PMOS transistor having its source connected to the supply voltage terminal, its gate connected to an output terminal of the error amplifying unit, and a drain connected to the feedback voltage regulating unit, wherein the PMOS transistor regulates a source-drain current according to the gate signal.

17. The voltage regulator of claim 14, wherein the voltage detecting unit includes at least two detection resistors, first and second detection resistors connected between the supply voltage terminal and the ground, wherein the detected voltage is provided at a connection node between the first and second detection resistors.

18. The voltage regulator of claim 14, wherein the feedback control unit provides a feedback control signal including first to nth control signals, states of the first to nth control signals being determined according to an amplitude of the detected voltage.

19. The voltage regulator of claim 14, wherein the feedback control unit includes:
a comparator comparing the detected voltage with first to nth reference voltages to provide first to Nth comparison signals, respectively, wherein the first to Nth comparison signals have a high level if the detected voltage is higher than corresponding reference voltages and have a low level otherwise, and a decoder decoding the first to Nth comparison signals into first to nth control signals of the feedback control signals to provide the feedback voltage regulating unit with the decoded signals.

20. The voltage regulator of claim 14, wherein the second resistor circuit part includes first to Nth switched resistors connected to one another in parallel to be switched on or off according to the feedback control signal, wherein each of the first to Nth switched resistors includes a switch and a resistor connected to each other in series.

21. An operation method of a voltage regulator of a low-drop-output type having an error amplifying unit providing a gate signal according to a voltage difference between a reference voltage and a feedback voltage and a semiconductor switch regulating a current between a supply voltage terminal and a ground according to the gate signal, the method comprising:
detecting, by a voltage detecting unit, the supply voltage to provide a detected voltage;
providing, by a feedback control unit, a feedback control signal according to the detected voltage; and
regulating, by a feedback voltage regulating unit connected between the semiconductor switch and the ground, the feedback voltage according to the feedback control signal.

22. The operation method of claim 21, wherein the error amplifying unit includes an operational amplifier having an inverting input terminal to receive the reference voltage, an non-inverting input terminal to receive the feedback voltage, and an output terminal connected to the semiconductor switch to provide the gate signal, and wherein the gate signal has a level corresponding to the voltage difference between the reference voltage and the feedback voltage.

23. The operation method of claim 21, wherein the semiconductor switch includes a PMOS transistor having its source connected to the supply voltage terminal, its gate connected to an output terminal of the error amplifying unit, and a drain connected to the feedback voltage regulating unit, wherein the PMOS transistor regulates a source-drain current according to the gate signal.

24. The operation method of claim 21, wherein the providing of the feedback control signal includes:
comparing, by the feedback control unit, the detected voltage with first to nth reference voltages to provide first to Nth comparison signals, respectively; and
decoding the first to Nth comparison signals into first to nth control signals of the feedback control signals to provide the feedback voltage regulating unit with the decoded signals,
wherein the first to Nth comparison signals have a high level if the detected voltage is higher than corresponding reference voltages and have a low level otherwise.
